(19) United States
(12) Patent Application Publication
(10) Pub. No.: US 2025/0355302 A1
(43) Pub. Date: Nov. 20, 2025

(54) LIQUID CRYSTAL PANEL

(71) Applicant: Japan Display Inc., Tokyo (JP)

(72) Inventors: Makoto ISHIKAWA, Tokyo (JP); Takaya HIROSE, Tokyo (JP)

(73) Assignee: Japan Display Inc., Tokyo (JP)

(21) Appl. No.: 19/206,152

(22) Filed: May 13, 2025

(30) Foreign Application Priority Data
May 15, 2024 (JP) 2024-079118

(51) Int. Cl. G02F 1/1343; G02F 1/1335; G02F 1/13363

(52) U.S. Cl. CPC G02F 1/1343; G02F 1/133528; G02F 1/13363

(57) ABSTRACT

According to an aspect, a liquid crystal panel has a first corner and a second corner, and an angle of the first corner is smaller than that of the second corner. The liquid crystal panel includes a first substrate, a second substrate, a liquid crystal layer, a first polarizer having a first polarization axis, a second polarizer having a second polarization axis orthogonal to the first polarization axis, and a retardation plate between the first and second polarizers and having a birefringence property. An initial orientation direction of liquid crystal molecules of the liquid crystal layer is parallel to the second polarization axis. The liquid crystal panel is such curved that a central part thereof has a valley shape. A fast axis of the retardation plate is tilted in a clockwise direction relative to the second polarization axis when viewed from a side where the valley shape is formed.

### CROSS-REFERENCE TO RELATED APPLICATION

This application claims the benefit of priority from Japanese Patent Application No. 2024-079118 filed on May 15, 2024, the entire contents of which are incorporated herein by reference.

### BACKGROUND

### 1. Technical Field

What is disclosed herein relates to a liquid crystal panel.

### 2. Description of the Related Art

Japanese Patent Application Laid-open Publication No. 2010-256680 (JP-A-2010-256680) discloses a liquid crystal display element (liquid crystal panel) that has a line symmetrical rectangular shape in plan view, and a curved shape in cross sectional view. The substrate included in the liquid crystal panel, which has a curved shape in cross sectional view, is subject to a bending stress. The bending stress causes birefringence. Furthermore, liquid crystal molecules also cause birefringence. The birefringence causes light leakage, which is a phenomenon in which light passes through the liquid crystal panel in a black display state.

The substrate of the liquid crystal panel disclosed in JP-A-2010-256680 is provided with an optical compensation layer to cancel the retardation caused by the birefringence. This structure prevents the light leakage of the liquid crystal panel in a black display state.

Some liquid crystal panels have an asymmetric shape in plan view, unlike the shape of the liquid crystal panel disclosed in JP-A-2010-256680. In an example of such liquid crystal panels, when the angle formed by two sides forming a corner of the liquid crystal panel is an acute angle in plan view, the stress is concentrated on a portion corresponding to the corner of the liquid crystal panel, resulting in a relative increase in stress magnitude and retardation at the portion of the liquid crystal panel, which may lead to light leakage.

For the foregoing reasons, there is a need for reducing light leakage in a black display state in a liquid crystal panel having a shape in which an angle formed by two sides forming a corner in plan view is an acute angle.

### SUMMARY

According to an aspect, a liquid crystal panel has a first corner and a second corner that are adjacent to each other in plan view, and an angle formed by two sides of the first corner is smaller than an angle formed by two sides of the second corner. The liquid crystal panel includes: a first substrate; a second substrate that is disposed opposite the first substrate; a liquid crystal layer that is disposed between the first substrate and the second substrate; a first polarizer that is disposed opposite the liquid crystal layer with the first substrate therebetween and has a first polarization axis; a second polarizer that is disposed opposite the liquid crystal layer with the second substrate therebetween and has a second polarization axis orthogonal to the first polarization axis in plan view; and a retardation plate that is disposed between the first polarizer and the second polarizer and entirely has a birefringence property. An initial orientation direction of liquid crystal molecules of the liquid crystal layer is parallel to the second polarization axis. The liquid crystal panel is such curved that a central part of the liquid crystal panel has a valley shape in cross sectional view when the liquid crystal panel is cut by a plane orthogonal to the second polarization axis. A fast axis of the retardation plate is tilted in a clockwise direction relative to the second polarization axis in plan view when the liquid crystal panel is viewed from a side where the central part has the valley shape.

According to another aspect, a liquid crystal panel has a first corner and a second corner that are adjacent to each other in plan view, and an angle formed by two sides of the first corner is smaller than an angle formed by two sides of the second corner. The liquid crystal panel includes: a first substrate; a second substrate that is disposed opposite the first substrate; a liquid crystal layer that is disposed between the first substrate and the second substrate; a first polarizer that is disposed opposite the liquid crystal layer with the first substrate therebetween and has a first polarization axis; a second polarizer that is disposed opposite the liquid crystal layer with the second substrate therebetween and has a second polarization axis orthogonal to the first polarization axis in plan view; and a retardation plate that is disposed between the first polarizer and the second polarizer and entirely has a birefringence property. An initial orientation direction of liquid crystal molecules of the liquid crystal layer is parallel to the second polarization axis. The liquid crystal panel is such curved that a central part of the liquid crystal panel has a valley shape in cross sectional view when the liquid crystal panel is cut by a plane parallel to the second polarization axis. A fast axis of the retardation plate is tilted in a counterclockwise direction relative to the second polarization axis in plan view when the liquid crystal panel is viewed from a side where the central part has the valley shape.

### BRIEF DESCRIPTION OF THE DRAWINGS

FIG. 1 is a plan view of a liquid crystal panel according to an embodiment of the present disclosure;

FIG. 2 is a cross section of the liquid crystal panel cut by a plane orthogonal to a Y direction;

FIG. 3 is a partial cross section illustrating a structure of the liquid crystal panel;

FIG. 4 is an exploded perspective view of the liquid crystal panel;

FIG. 5 is a diagram illustrating a relation between a second polarization axis and both of a fast axis and a slow axis of a retardation plate; and

FIG. 6 is a diagram illustrating a relation between a tilt angle and an amount of light leakage.

### DETAILED DESCRIPTION

An embodiment of the present disclosure is described in detail with reference to the drawings. The present disclosure is not limited by the following embodiment. Components described below include those easily conceivable by those skilled in the art and substantially the same components. Furthermore, the components described below can be appropriately combined.

What is disclosed herein is merely an example, and appropriate modifications within the gist of the present disclosure of which those skilled in the art can easily think are naturally encompassed in the scope of the present disclosure. In the drawings, widths, thicknesses, shapes, and the like of the components can be schematically illustrated in comparison with actual aspects for more clear explanation. They are, however, merely examples and do not limit interpretation of the present disclosure. In the present specification and the drawings, the same reference numerals denote components similar to those described before with reference to the drawing that has been already referred, and the detail explanation thereof can be appropriately omitted.

The X direction illustrated in the drawings is the width direction of a liquid crystal panel 1. The Y direction is the height direction of the liquid crystal panel 1 and is orthogonal to the X direction. The Z direction is the depth direction of the liquid crystal panel 1 and is orthogonal to the X and Y directions. The +Z side in the Z direction (the side indicated by the arrow) corresponds to the side closer to a front surface 1a on which an image is displayed on the liquid crystal panel 1 while the −Z side in the Z direction (the side opposite to that indicated by the arrow) corresponds to the side closer to a rear surface of the liquid crystal panel 1.

In the specification, the description “in plan view” means viewing the liquid crystal panel 1 along the Z direction. The X, Y, and Z directions are examples, and the present disclosure is not limited to these directions.

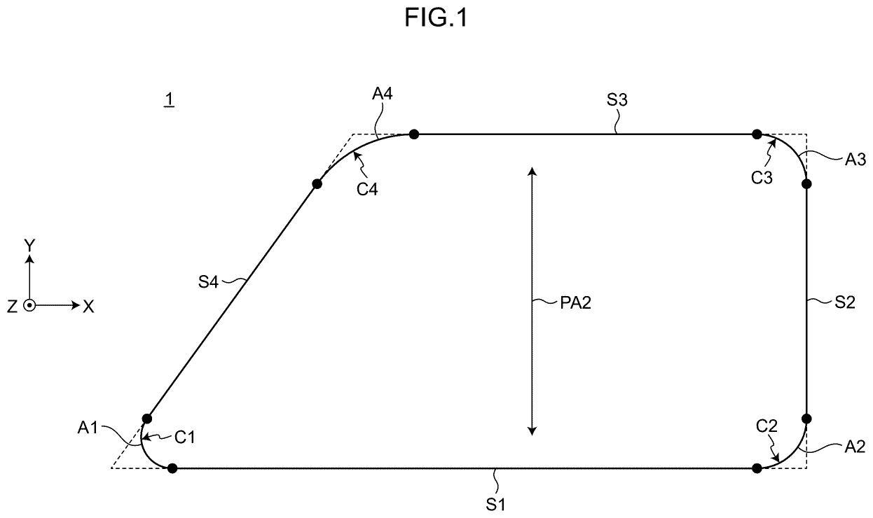

FIG. 1 is a plan view of the liquid crystal panel 1 according to the embodiment of the present disclosure. The liquid crystal panel 1 is a liquid crystal display of a transmissive type. The liquid crystal panel 1, which has a rectangular shape asymmetrical with respect to a line along the Y direction in plan view, has a first corner C1, a second corner C2, a third corner C3, and a fourth corner C4.

The first corner C1 is composed of a fourth side S4, a first side S1, and a first arc A1 coupling the fourth side S4 and the first side S1. The second corner C2 is composed of the first side S1, a second side S2, and a second arc A2 coupling the first side S1 and the second side S2. The third corner C3 is composed of the second side S2, a third side S3, and a third arc A3 coupling the second side S2 and the third side S3. The fourth corner C4 is composed of the third side S3, the fourth side S4, and a fourth arc A4 coupling the third side S3 and the fourth side S4.

The first corner C1 is adjacent to the second corner C2 and the fourth corner C4. The first corner C1 is opposite the third corner C3.

In plan view, the angle formed by the two sides included in the first corner C1 (i.e., the fourth side S4 and the first side S1) is an acute angle. In plan view, the angle formed by the two sides included in the second corner C2 (i.e., the first side S1 and the second side S2) is a right angle. Therefore, in plan view, the angle formed by the two sides included in the first corner C1 is an acute angle smaller than the angle formed by the two sides included in the second corner C2.

The angle formed by the two sides included in the third corner C3 (i.e., the second side S2 and the third side S3) is a right angle. The angle formed by the two sides included in the fourth corner C4 (i.e., the third side S3 and the fourth side S4) is an obtuse angle.

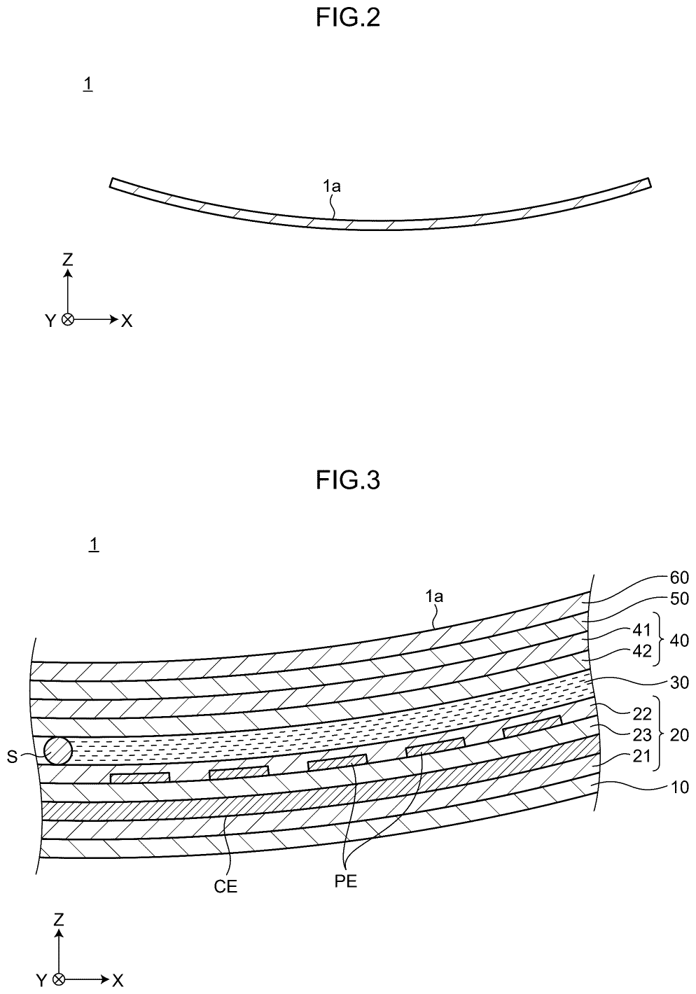

FIG. 2 is a cross section of the liquid crystal panel 1 cut by a plane orthogonal to the Y direction. The liquid crystal panel 1 is such curved that the central part thereof in the X direction forms a valley in cross sectional view illustrated in FIG. 2. Specifically, the liquid crystal panel 1 is curved with a protruding shape toward the −Z side. More specifically, the liquid crystal panel 1 is curved with a protruding shape toward the −Z side in the cross section cut by the plane orthogonal to the Y direction, and is not curved but flat in the cross section cut by the plane orthogonal to the X direction.

The front surface 1a of the liquid crystal panel 1 is curved toward the −Z side with a protruding shape having a substantially constant curvature. Specifically, the front surface 1a of the liquid crystal panel 1 is curved toward the −Z side with a protruding shape having a substantially constant curvature in cross sectional view when the liquid crystal panel 1 is cut by the plane orthogonal to the Y direction. The curvature of the front surface 1a is not limited to a substantially constant curvature. The front surface 1a of the liquid crystal panel 1 has a linear shape in cross sectional view when the liquid crystal panel 1 is cut by the plane orthogonal to the X direction.

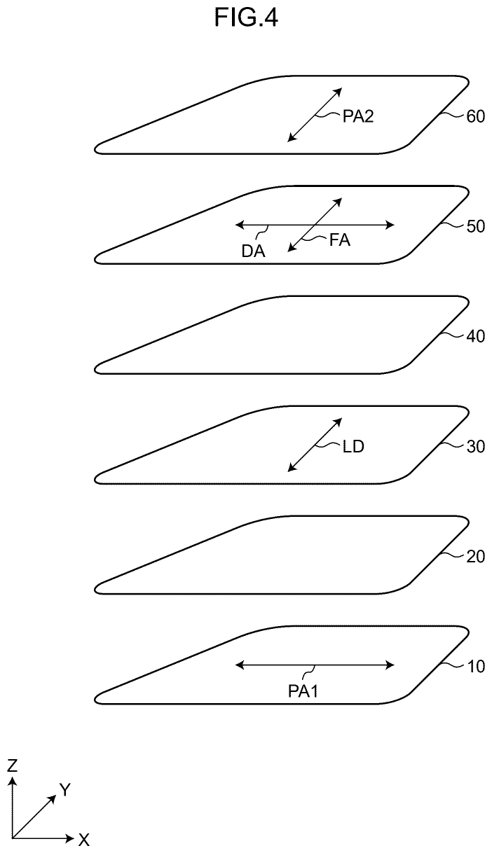

FIG. 3 is a partial cross section illustrating the structure of the liquid crystal panel 1. FIG. 4 is an exploded perspective view of the liquid crystal panel 1. The liquid crystal panel 1 is liquid crystal display of a lateral electric field type (e.g., fringe field switching (FFS) type). The liquid crystal panel 1 is a liquid crystal display of a normally black type.

The liquid crystal panel 1 includes a first polarizer 10, a first substrate 20, a liquid crystal layer 30, a second substrate 40, a retardation plate 50, and a second polarizer 60. The first polarizer 10, the first substrate 20, the liquid crystal layer 30, the second substrate 40, the retardation plate 50, and the second polarizer 60 are stacked in this order from the −Z to +Z side.

The first polarizer 10, the first substrate 20, the liquid crystal layer 30, the second substrate 40, the retardation plate 50, and the second polarizer 60 are each curved along the curve of the front surface 1a. In FIG. 4, the first polarizer 10, the first substrate 20, the liquid crystal layer 30, the second substrate 40, the retardation plate 50, and the second polarizer 60 are illustrated without being curved for convenience of explanation.

The first polarizer 10 is disposed opposite the liquid crystal layer 30 with the first substrate 20 therebetween and has a first polarization axis PA1 illustrated in FIG. 4. The first polarization axis PA1 is parallel to the X direction in plan view.

As illustrated in FIG. 3, the first substrate 20 includes a first insulating substrate 21, a first alignment film 22, an insulating film 23, a common electrode CE, and a plurality of pixel electrodes PE. The first alignment film 22 is in contact with the liquid crystal layer 30. The first insulating substrate 21 is formed of a photoelastic material having a light-transmitting property (e.g., glass).

The common electrode CE is provided between the first insulating substrate 21 and the insulating film 23 having a light-transmitting property. The pixel electrodes PE are provided between the insulating film 23 and the first alignment film 22. The common electrode CE and the pixel electrodes PE are formed of conductive materials with a light-transmitting property (e.g., indium tin oxide (ITO) and indium zinc oxide (IZO)).

The pixel electrodes PE overlap with the common electrode CE in a display region displaying images on the front surface 1a of the liquid crystal panel 1.

The liquid crystal layer 30 is disposed between the first substrate 20 and the second substrate 40. The liquid crystal layer 30 contains a plurality of liquid crystal molecules. In the initial state when no voltages are applied to the common electrode CE and the pixel electrodes PE, the liquid crystal molecules are such aligned that the long axes of the liquid crystal molecules are along the initial alignment direction LD illustrated in FIG. 4 by the first alignment film 22 and a second alignment film 42, which is described later. The initial orientation direction LD is parallel to a second polarization axis PA2, which is described later, in plan view.

The second substrate 40 is disposed opposite the first substrate 20. As illustrated in FIG. 3, the second substrate 40 includes a second insulating substrate 41 and the second alignment film 42. The second insulating substrate 41 is formed of a photoelastic material having a light-transmitting property (e.g., glass). The second alignment film 42 is in contact with the liquid crystal layer 30.

The retardation plate 50 is disposed between the first polarizer 10 and the second polarizer 60 and entirely has a light-transmitting property and a birefringent property. Specifically, the retardation plate 50 is disposed between the second substrate 40 and the second polarizer 60. The retardation generated in light passing through the retardation plate 50 due to the birefringence property of the retardation plate 50 is approximately constant across the entire retardation plate 50. This birefringence property is adjusted in advance on the basis of the characteristics of the liquid crystal layer 30 and other factors. The retardation plate 50 has a fast axis FA and a slow axis DA corresponding to the birefringence property of the retardation plate 50.

The second polarizer 60 is disposed opposite the liquid crystal layer 30 with the second substrate 40 therebetween and has the second polarization axis PA2 illustrated in FIG. 4. The second polarization axis PA2 is orthogonal to the first polarization axis PA1 in plan view. In other words, the second polarization axis PA2 is parallel to the Y direction in plan view.

The liquid crystal panel 1 further includes a sealing member S that seals the liquid crystal in the liquid crystal layer 30. The sealing member S is sandwiched between the first substrate 20 and the second substrate 40 and is disposed around the entire periphery of the liquid crystal panel 1.

FIGS. 3 and 4 illustrate only the main part of the liquid crystal panel 1 in a simplified form. The liquid crystal panel 1 thus further includes components that are not illustrated in FIGS. 3 and 4. For example, the first substrate 20 includes a light shielding layer, a color filter layer, an overcoat layer, and a spacer. The first substrate 20 further includes a plurality of scan lines, a plurality of signal lines, switching elements each electrically coupled to one of the pixel electrodes PE, and various insulating films.

In the liquid crystal panel 1 structured as described above, voltages applied to the pixel electrodes PE and common electrode CE are controlled on the basis of image data input from an external device (not illustrated), whereby the orientations of liquid crystal molecules are controlled. As a result, light that is emitted from a backlight (not illustrated) or the like, passes through the first polarizer 10 and is modulated while passing through the liquid crystal layer 30. Thereafter, the light after passing through the second polarizer 60 is displayed as an image in the display region. When no voltages are applied to the pixel electrodes PE and the common electrode CE, the liquid crystal molecules are along the initial orientation direction LD, and black color is displayed in the display region.

As described above, the liquid crystal panel 1 is curved with a protruding shape toward the −Z side in the cross section cut by the plane orthogonal to the Y direction (i.e., the direction in which the second polarization axis PA2 extends) and is not curved but flat in the cross section cut by the plane orthogonal to the X direction. The first substrate 20 and the second substrate 40 sandwich the sealing member S across the entire periphery of the liquid crystal panel 1. The stiffness of the periphery of the liquid crystal panel 1 is thus higher than that of the central part of the liquid crystal panel 1.

In this case, the curve of the liquid crystal panel 1 affects the first substrate 20 and the second substrate 40 individually in the central part of the liquid crystal panel 1. Specifically, in the first insulating substrate 21, a compressive stress occurs on the +Z side while a tensile stress occurs on the −Z side. This results in birefringence that is different between a portion on the +Z side and a portion on the −Z side in the first insulating substrate 21. Specifically, in the first insulating substrate 21, the fast axis of birefringence occurring on the +Z side and the fast axis of birefringence occurring on the −Z side are orthogonal to each other. Thus, the retardation due to the birefringence is compensated in the first insulating substrate 21. In the second insulating substrate 41, the retardation due to the birefringence is compensated in the same manner as the first insulating substrate 21. The stresses developed in the first insulating substrate 21 and the second insulating substrate 41 do not affect the liquid crystal layer 30. No retardation thus occurs in the light passing through the liquid crystal layer 30 in the central part of the liquid crystal panel 1. In other words, leakage of light (hereinafter simply referred to as “light leakage”) does not occur in the central part of the liquid crystal panel 1 when black is displayed in the display region.

On the other hand, in the periphery of the liquid crystal panel 1, the curve of the liquid crystal panel 1 affects each of the first substrate 20, the liquid crystal layer 30, and the second substrate 40 while they are integrated. Specifically, a tensile stress occurs in the first insulating substrate 21 while a compressive stress occurs in the second insulating substrate 41. This results in birefringence in each of the first insulating substrate 21 and the second insulating substrate 41. The fast axis of the birefringence occurring in the first insulating substrate 21 and the fast axis of the birefringence occurring in the second insulating substrate 41 are orthogonal to each other. The retardation due to the birefringence in the first insulating substrate 21 is compensated by the retardation due to the birefringence in the second insulating substrate 41.

In this case, in the periphery of the liquid crystal panel 1, the tensile stress developed in the first insulating substrate 21 and the compressive stress developed in the second insulating substrate 41 affect the liquid crystal layer 30. This results in a retardation in the light passing through the liquid crystal layer 30. The retardation is not compensated by the second polarizer 60 and becomes a factor of the light leakage.

The angle formed by the two sides of the first corner C1 is smaller than the angles each of which is formed by the two sides of any one of the other corners. The tensile stress developed in the first insulating substrate 21 and the compressive stress developed in the second insulating substrate 41 in the first corner C1 are thus larger than those in the other corners. As a result, the retardation of the light passing through the liquid crystal layer 30 in the first corner C1 is larger than those in the other corners. In other words, light leakage is more likely to occur in the portion of the first corner C1 than in the portions of the other corners in the liquid crystal panel 1.

To reduce such light leakage, the fast axis FA of the retardation plate 50 is tilted in a clockwise direction relative to the second polarization axis PA2 in plan view of the liquid crystal panel 1 when the liquid crystal panel 1 is viewed from the side where the central part of the liquid crystal panel 1 has a valley shape (i.e., +Z side).

FIG. 5 is a diagram illustrating a relation between the second polarization axis PA2 and both of the fast axis FA and the slow axis DA of the retardation plate 50. The fast axis FA and the slow axis DA are orthogonal to each other. The direction indicated by the bold arrow B in FIG. 5 is the clockwise direction in plan view of the liquid crystal panel 1 viewed from the +Z side. The tilt angle θ of the fast axis FA relative to the second polarization axis PA2 in plan view in FIG. 5 is such determined that light leakage is reduced.

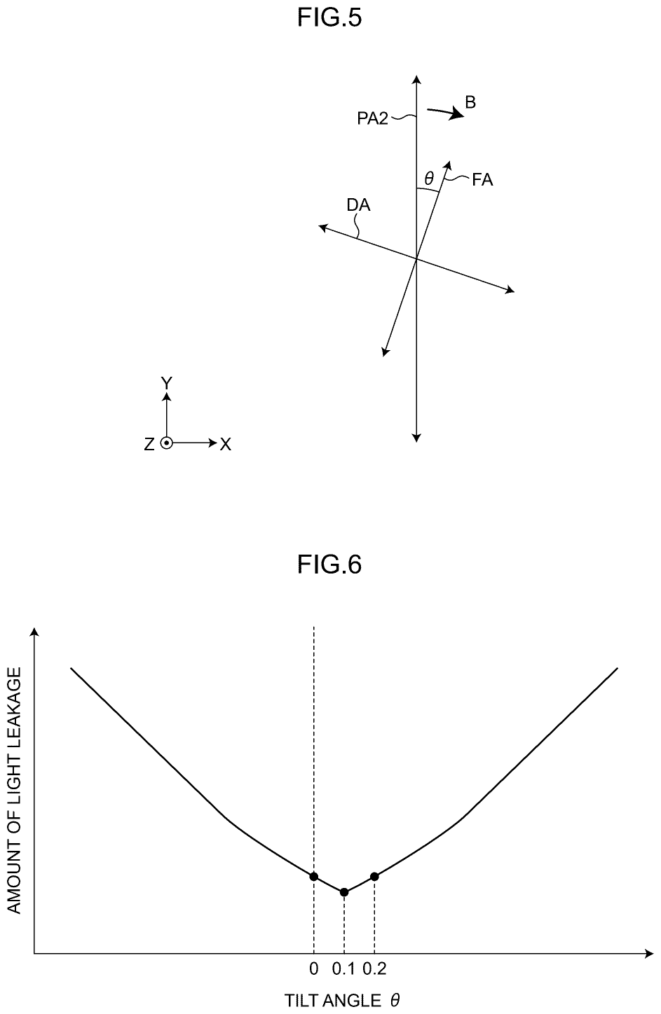

FIG. 6 is a diagram illustrating a relation between the tilt angle θ and the amount of light leakage. The vertical axis illustrated in FIG. 6 represents the total amount of light leakage (the amount of light that has leaked) when the total amount of light incident on the liquid crystal panel 1 is set to 1. The horizontal axis illustrated in FIG. 6 represents the tilt angle θ of the fast axis FA relative to the second polarization axis PA2 in plan view. The direction (plus direction) indicated by the arrow of the horizontal axis is the same as the direction indicated by the bold arrow B in FIG. 5.

When the tilt angle θ is 0 (zero), the amount of light leakage is approximately 1.7E-0.4. When the tilt angle θ is increased from 0 to +0.1°, the amount of light leakage is reduced to approximately 1.4E-0.4, or by approximately 18%. When the tilt angle θ is set to +0.2°, the amount of light leakage increases and becomes substantially equal to the amount of light leakage when the tilt angle θ is 0. On the other hand, as the tilt angle θ increases from 0 to the minus direction (opposite to the plus direction), the amount of light leakage increases.

Consequently, when the tilt angle θ of the fast axis FA relative to the second polarization axis PA2 is larger than 0° and less than 0.2° in plan view of the liquid crystal panel 1 viewed from the +Z side, the amount of light leakage is reduced, thereby making it possible to reduce the light leakage of the liquid crystal panel 1 in a black display state.

When the tilt angle θ of the fast axis FA relative to the second polarization axis PA2 is within a range of 0.05° to 0.15° in plan view of the liquid crystal panel 1 viewed from the +Z side, the amount of light leakage is reliably reduced, thereby making it possible to reliably reduce the light leakage of the liquid crystal panel 1 in a black display state.

Although the embodiment of the present disclosure has been described, the present disclosure is not limited to the embodiment. The contents disclosed in the embodiment are only examples and various modifications can be made without departing from the purpose of the present disclosure. Any appropriate modifications made within the scope that does not depart from the purpose of the present disclosure naturally belong to the technical scope of the present disclosure. At least one of various omissions, substitutions, and modifications of the components can be made in a scope without departing from the gist of the embodiments and modifications described above.

For example, the angle formed by the two sides of the second corner C2 may be an obtuse angle, or an acute angle larger than the angle formed by the two sides of the first corner C1. The angle formed by the two sides included in the third corner C3 may be an acute angle smaller than the angle formed by the two sides included in the second corner C2.

The liquid crystal panel 1 may have a polygonal shape with five or more corners.

The first corner C1 may be shaped by the fourth side S4 and the first side S1 that intersect each other without the first arc A1. The second corner C2 may be shaped by the first side S1 and the second side S2 that intersect each other without the second arc A2. The third corner C3 may be shaped by the second side S2 and the third side S3 that intersect each other without the third arc A3. The fourth corner C4 may be shaped by the third side S3 and the fourth side S4 that intersect each other without the fourth arc A4.

The retardation plate 50 may be disposed between the first polarizer 10 and the first substrate 20, for example. The retardation plate 50 may be included in the first substrate 20 or the second substrate 40. In this case, the fast axis FA of the retardation plate 50 is tilted in a counterclockwise direction relative to the second polarization axis PA2 in plan view of the liquid crystal panel 1 when the liquid crystal panel 1 is viewed from the side where the central part of the liquid crystal panel 1 has a valley shape (i.e., +Z side).

The liquid crystal panel 1 may be curved with a protruding shape toward the +Z side in the cross section cut by the plane orthogonal to the Y direction (i.e., the direction in which the second polarization axis PA2 extends) and may be not curved but flat in the cross section cut by the plane orthogonal to the X direction. In this case, the fast axis FA of the retardation plate 50 is tilted in a clockwise direction relative to the second polarization axis PA2 in plan view of the liquid crystal panel 1 when the liquid crystal panel 1 is viewed from the side where the central part of the liquid crystal panel 1 has a valley shape (i.e., the −Z side).

The liquid crystal panel 1 may be curved with a protruding shape toward the −Z side in the cross section cut by the plane parallel to the Y direction (i.e., the direction in which the second polarization axis PA2 extends) and may be not curved but flat in the cross section cut by the plane parallel to the X direction. In this case, the fast axis FA of the retardation plate 50 is tilted in a counterclockwise direction relative to the second polarization axis PA2 in plan view of the liquid crystal panel 1 when the liquid crystal panel 1 is viewed from the side where the central part of the liquid crystal panel 1 has a valley shape (i.e., +Z side).

The liquid crystal panel 1 may be curved with a protruding shape toward the +Z side in the cross section cut by the plane parallel to the Y direction (i.e., the direction in which the second polarization axis PA2 extends) and may be not curved but flat in the cross section cut by the plane parallel to the X direction. In this case, the fast axis FA of the retardation plate 50 is tilted in a counterclockwise direction relative to the second polarization axis PA2 in plan view of the liquid crystal panel 1 when the liquid crystal panel 1 is viewed from the side where the central part of the liquid crystal panel 1 has a valley shape (i.e., the −Z side).

Other operations and effects provided by the modes described in the embodiment that are obvious from description of the present specification or conceivable by those skilled in the art should naturally be interpreted to be provided by the present disclosure.

What is claimed is:

1. A liquid crystal panel having a first corner and a second corner that are adjacent to each other in plan view, an angle formed by two sides of the first corner being smaller than an angle formed by two sides of the second corner, the liquid crystal panel comprising:
a first substrate;
a second substrate that is disposed opposite the first substrate;
a liquid crystal layer that is disposed between the first substrate and the second substrate;
a first polarizer that is disposed opposite the liquid crystal layer with the first substrate therebetween and has a first polarization axis;
a second polarizer that is disposed opposite the liquid crystal layer with the second substrate therebetween and has a second polarization axis orthogonal to the first polarization axis in plan view; and
a retardation plate that is disposed between the first polarizer and the second polarizer and entirely has a birefringence property, wherein
an initial orientation direction of liquid crystal molecules of the liquid crystal layer is parallel to the second polarization axis,
the liquid crystal panel is such curved that a central part of the liquid crystal panel has a valley shape in cross sectional view when the liquid crystal panel is cut by a plane orthogonal to the second polarization axis, and
a fast axis of the retardation plate is tilted in a clockwise direction relative to the second polarization axis in plan view when the liquid crystal panel is viewed from a side where the central part has the valley shape.

2. The liquid crystal panel according to claim 1, wherein the angle formed by the two sides of the second corner is a right angle or an obtuse angle in plan view.

3. The liquid crystal panel according to claim 1, wherein
the liquid crystal panel has a third corner adjacent to the second corner in plan view, and
an angle formed by two sides of the third corner is an acute angle smaller than the angle formed by the two sides of the second corner.

4. The liquid crystal panel according to claim 1, wherein the first substrate comprises a common electrode and a plurality of pixel electrodes.

5. The liquid crystal panel according to claim 1, wherein a tilt angle of the fast axis relative to the second polarization axis in plan view is greater than 0° and less than 0.2°.

6. The liquid crystal panel according to claim 1, wherein a tilt angle of the fast axis relative to the second polarization axis in plan view is within a range of 0.05° to 0.15°.

7. A liquid crystal panel having a first corner and a second corner that are adjacent to each other in plan view, an angle formed by two sides of the first corner being smaller than an angle formed by two sides of the second corner, the liquid crystal panel comprising:
a first substrate;
a second substrate that is disposed opposite the first substrate;
a liquid crystal layer that is disposed between the first substrate and the second substrate;
a first polarizer that is disposed opposite the liquid crystal layer with the first substrate therebetween and has a first polarization axis;
a second polarizer that is disposed opposite the liquid crystal layer with the second substrate therebetween and has a second polarization axis orthogonal to the first polarization axis in plan view; and
a retardation plate that is disposed between the first polarizer and the second polarizer and entirely has a birefringence property, wherein
an initial orientation direction of liquid crystal molecules of the liquid crystal layer is parallel to the second polarization axis,
the liquid crystal panel is such curved that a central part of the liquid crystal panel has a valley shape in cross sectional view when the liquid crystal panel is cut by a plane parallel to the second polarization axis, and
a fast axis of the retardation plate is tilted in a counterclockwise direction relative to the second polarization axis in plan view when the liquid crystal panel is viewed from a side where the central part has the valley shape.
